(19) United States
(12) Patent Application Publication
(10) Pub. No.: US 2013/0045774 A1
(43) Pub. Date: Feb. 21, 2013

(54) Smart Phone Writing Method and Apparatus

(71) Applicant: Vacit Arat, La Canada - Flintridge, CA (US)

(72) Inventor: Vacit Arat, La Canada - Flintridge, CA (US)

(73) Assignee: Sigza Authentication Systems

(21) Appl. No.: 13/558,270

(22) Filed: Jul. 25, 2012

Related U.S. Application Data
(63) Continuation-in-part of application No. 13/314,059, filed on Dec. 7, 2011.
(60) Provisional application No. 61/511,532, filed on Jul. 25, 2011.
(60) Provisional application No. 61/511,535, filed on Jul. 25, 2011.
(60) Provisional application No. 61/511,532, filed on Jul. 25, 2011.
(60) Provisional application No. 61/488,692, filed on May 20, 2011.
(60) Provisional application No. 61/438,631, filed on Feb. 1, 2011.
(60) Provisional application No. 61/420,729, filed on Dec. 7, 2010.

(51) Int. Cl. H04W 88/02

(52) U.S. Cl. 455/556.1

(57) ABSTRACT

Embodiments are directed to apparatus, methods and systems for capturing and using writing or drawing motions made while holding a handheld electronic device (e.g. smart phone) that include one or more of a variety of sensors (e.g. inertial sensors, touch sensors, pressure sensors, optical sensors, and the like). The writing or drawing movements are processed into writing or drawing data that may be used as communication data or as verification data when compared to previously recorded data.

### RELATED APPLICATIONS

This application claims benefit of U.S. Provisional Patent Application No. 61/511,532, filed Jul. 25, 2011 and this application is a CIP of U.S. patent application Ser. No. 13/314,059, filed Dec. 7, 2012 which in turn benefit of U.S. Provisional Patent Application Nos. 61/511,535, filed Jul. 25, 2011; 61/511,532, filed Jul. 25, 2011; 61/488,692, filed May 31, 2011; 61/438,631, filed Feb. 1, 2011; and 61/420,729, filed Dec. 7, 2010, respectively. The teachings of the '535, '532, and '059 applications are incorporated herein by reference as if set forth in full herein.

### FIELD OF THE INVENTION

The present invention relates generally to the field of inertial sensing and data capturing and more particularly to inertial sensing and data capture by handheld devices, such as smart phones, wherein captured inertial data is used to interpret motions of the device as writings or drawings.

### BACKGROUND OF THE INVENTION

Inertial data from hand held devices has been used for, or proposed for use in, a variety of applications some of which are discussed in published US Patent Application Publication No. US 2010/0214216, Aug. 26, 2010, by Nasiri et al., and entitled Motion Sensing and Processing on Mobile Devices. This application is incorporated herein by reference as if set forth in full herein.

Consumers can benefit from additional mobile device applications that can further enhance productivity and usefulness of such devices.

### SUMMARY OF THE INVENTION

It is an object of some embodiments of the invention to provide a method for recording and capturing information about a writing or drawing using at least one inertial sensor and then displaying that information or otherwise using that information for an intended purpose of the writing or drawing.

Other objects and advantages of various embodiments of the invention will be apparent to those of skill in the art upon review of the teachings herein. The various embodiments of the invention, set forth explicitly herein or otherwise ascertained from the teachings herein, may address one or more of the above objects alone or in combination, or alternatively may address some other object ascertained from the teachings herein. It is not necessarily intended that all objects be addressed by any single aspect of the invention even though that may be the case with regard to some aspects.

In a first aspect of the invention a method for creating a writing or drawing includes: (a) providing a handheld device having at least one inertial measurement sensor; (b) initiating a writing or drawing capture event; (c) undergoing a series of writing or drawing motions wherein the motions are detected by the at least one inertial measurement sensor; (d) ending a writing or drawing capture event; and (e) processing the sensor recordings into a writing or drawing.

In a second aspect of the invention the handheld device of the first aspect of the invention includes a cell phone.

In a third aspect of the invention the cell phone of the second aspect includes a smart phone.

In a fourth aspect of the invention the at least one inertial sensor of any of the first-third aspects includes at least one sensor for detecting a linear acceleration along an axis.

In a fifth aspect of the invention the at least one inertial sensor of the first-third aspects includes at least one sensor for detecting linear acceleration along at least two perpendicular axes.

In a sixth aspect of the invention the at least one inertial sensor of any of the first-third aspects includes at least one sensor for detecting linear acceleration along three perpendicular axes.

In a seventh aspect of the invention the at least on inertial sensor of any of the first-sixth aspects includes at least one sensor for detecting an angular acceleration about an axis.

In an eighth aspect of the invention the at least one inertial sensor of any of the first-sixth aspects includes at least one sensor for detecting an angular acceleration about at least two perpendicular axes.

In a ninth aspect of the invention the at least one inertial sensor of any of the first-sixth aspects includes at least one sensor for detecting an angular acceleration about three perpendicular axes.

In a tenth aspect of the invention the initiating of a writing capture event in any of the first-ninth aspects occurs by a writer entering a particular application running on the handheld device and performing an action selected from the group consisting of: (1) pressing a button on the body of the device, (2) activating a touch sensor associated with a writing contact feature of the device, and (3) applying adequate pressure to a pressure sensor associated with a writing contact feature of the device.

In an eleventh aspect of the invention the initiating of a writing capture event of any of the first-ninth aspect occurs by a writer causing the handheld device to move through a defined sequence of motions.

In a twelfth aspect of the invention the defined sequence of motions of the eleventh aspect is preceded by running a particular application on the handheld device.

In a thirteenth aspect of the invention the initiating of writing capture of any of the first-twelfth aspects includes pressing one or more contact locations on a touch screen on the handheld device.

In a fourteenth aspect of the invention the initiating of writing capture of the first-thirteenth aspect includes issuance of a voice command.

In a fifteenth aspect of the invention the writing or drawing motions of any of the first-fourteenth aspects are also detected by a proximity sensor that provides a distance indication relative to a surface over which the handheld device is moved.

In a sixteenth aspect of the invention the writing or drawing motions of any of the first-fifteenth aspects are also detected by a contact sensor that provides a contact/no-contact indication relative to a surface over which the handheld device is moved.

In a seventeenth aspect of the invention the writing or drawing motions of any of the first-sixteenth aspects are also detected by a pressure sensor that provides a pressure indication when a surface over which the handheld device is moved.

In an eighteenth aspect of the invention, the method of any of the first-seventeenth aspects include a camera that is used to detect landmarks on a surface over which the device is moved during the writing or drawing motions.

In a nineteenth aspect of the invention, the method of any of the first-seventeenth aspects include a camera that is used to detect marks on a surface when the device contacts the surface during the writing or drawing motions.

In a twentieth aspect of the invention the marks of the nineteenth aspect include the writing or drawing made during the writing or drawing motions.

In a twenty-first aspect of the invention the handheld device of any of the first-twentieth aspects of the invention includes a stylus that is moved against a surface during at least a portion of the writing or drawing motions.

In a twenty-second aspect of the invention the handheld device of any of the first-twentieth aspects of the invention includes a writing instrument that can mark a surface and that is moved against a surface during at least a portion of the writing or drawing motions.

In a twenty-third aspect of the invention the handheld device of any of the first-twentieth aspects includes a laser that can at least temporarily mark a surface and that is made to mark the surface during at least a portion of the writing or drawing motions.

In a twenty-fourth aspect of the invention the handheld device of any of the first-twenty-third aspects includes a display screen that displays an image derived from the writing or drawing that is being created.

In a twenty-fifth aspect of the invention the handheld device of any of the first-twenty-third aspects includes a display screen which does not display an image that is derived from writing or drawing being created.

In a twenty-sixth aspect of the invention the writing or drawing motions of any of the first-twenty-fifth aspects give rise to data that is transferred from the handheld device to another device and the transferred data is interpreted by the other device to create and display the writing or drawing.

In a twenty-seventh aspect of the invention the writing or drawing of any of the first-twenty-sixth aspects are interpreted as 2-D writing or drawings.

In a twenty-eighth aspect of the invention the writing or drawing of any of the first-twenty-sixth aspects in interpreted as a 3-D structure.

In a twenty-ninth aspect of the invention the writing or drawing of any of the first-twenty-eight aspects is interpreted using character recognition algorithms (e.g. OCR algorithms).

In a thirtieth aspect of the invention the processing of the motions into a writing or drawing of any of the first-twenty-ninth aspects occurs in real time by the handheld device.

In a thirty-first aspect of the invention the processing of the motions into a writing or drawing of any of the first-twenty-ninth aspects occur after completion of the writing or drawing movements.

In a thirty-second aspect of the invention information extracted from the writing or drawing motions of any of the first-thirty-first aspects in an application selected from the group consisting of (1) a text message; (2) a phone number; (3) a web search; (4) a report; (5) notes; and (6) a signature.

In a thirty-third aspect of the invention information extracted from the writing or drawing motions of any of the first-thirty-second aspects is compared to previously recorded information to provide a writing analysis, signature verification, or identity verification or confirmation.

Other aspects of the invention will be understood by those of skill in the art upon review of the teachings herein. Other aspects of the invention may involve combinations of the above noted aspects of the invention. These other aspects of the invention may provide other configurations, structures, functional relationships, and processes that have not been specifically set forth above.

### BRIEF DESCRIPTION OF THE DRAWINGS

FIG. 1 illustrates the result of a movement of a smart phone, the detection of at least certain aspects of the motion by inertial sensors within the phone, the capture of at least certain features of the detected motion, and the translation of at least a portion of the captured features into a display image that is shown on the screen of the smart phone.

### DETAILED DESCRIPTION OF PREFERRED EMBODIMENTS

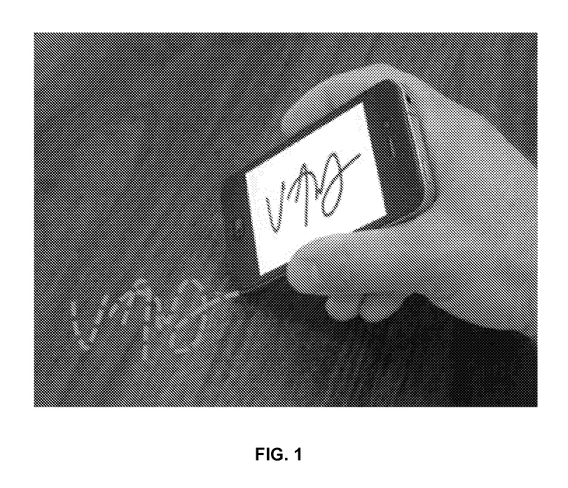

A smart Phone, or other handheld device such as a camera or a PDA, may be held like a pen, and a corner of it, or some device attached to it, may be used as if it is the tip of the pen. The handheld device may go through the motions of writing or drawing things on a surface (as shown in FIG. 1), or even in the air. Before or at the time of starting the motion, the handheld device may be instructed to capture and record the motion (e.g. by pressing a button or series of buttons, entering information into a touch screen, by voice command, by tapping a writing or drawing instrument that forms part of the handheld device against a surface in a particular way, or possibly but moving the device through a motion or series of motions that signal initiation of recording). After the capture motion, the device may be instructed to stop recording. During the record and capture period, the inertial sensors (e.g. accelerometers and gyroscopes) and possibly other sensors (e.g. proximity sensors, touch sensors, pressure sensors, and/or optical devices, e.g. digital or video cameras,) may capture information about the motion (linear accelerations in one or more directions, rotational accelerations about one or more axes), information about the relative location of the device to a surface, contact with a surface, absolute or relative pressure exerted by the device on a surface, recording of landmarks on the surface, and even marks made on the surface by the movement of the smart phone. In some embodiment variations, the handheld device may include or be capable of receiving a stylus or an actual writing instrument, or even laser pointer that can be used to make permanent or temporary marks on the surface.

This captured and recorded information may be processed by appropriate software and the device's microprocessor to re-create an actual or an appropriately scaled image of the writing on a display screen of the device. In other variations, the screen may remain blank or at least not show the image associated with the motions but instead the captured information may be sent to an external device (e.g. computer or data storage device) via a hardwired connection or via a wireless connection (e.g. over a phone network, a wireless internet connection, or the like) for subsequent processing, display, and/or other usage. In some embodiment variations the information stored on the screen may be limited to drawings (e.g. non characters) and characters that are recognized as such and then possibly displayed in a desired font.

In some embodiment variations, the processing of the recorded sensor data may be performed in real-time. In such variations, recorded information may be limited to information displayed and it may include, or be limited to, the original information that was captured and processed.

In some variations, any corner or side of the hand held device (e.g. smart phone) may be utilized as the tip of a virtual pen. In such variations, the corner being used may be specified by the user or may be automatically determined (e.g. based on an initial lowest corner of the device when data capture begins). In other variations, when an attachment is added to the device or extends from the device, an effective writing tip may be something located at a distance spaced from the normal surface of the device.

In still other variations, a realistic pen-tip may be placed, and held in place (e.g. in the headphone port of the smart phone, such that the user may actually be writing or drawing physically while the phone is recording the inertial and/or other data.

After the recorded data is processed and the handwriting is revealed, the data may then be processed by a character recognition software (e.g. optical character recognition software) to translate the handwriting into digital form. This may be done on the smart phone or a separate device/computer.

In some embodiment variations, recording of inertial data and/or other data may occur continuously and be sent to data storage wherein earlier recorded data is overwritten by new data as an allocated storage capacity is filled. In such embodiments, captured information, for example, may be processed into a writing or drawing after the motions have already occurred. In other variations, writing may be recognized and saved based on motion delimitating, or start/stop, signals to which the device has been subjected.

In some embodiment variations, the writing or drawing motions may give rise to data that is transferred from the handheld device to another device, the transferred data may be interpreted by the other device, and then transformed information sent back to the handheld device to display the writing or drawing.

Applications of such writings or drawings are extensive. The writing may be used as a data entry method for text messaging, entering phone numbers, web searching, report typing, memo or note taking including text and images, signature providing, and the like. In some such applications, the writing may remain in strictly an image format while in other applications some or all of the data may undergo some form of character recognition process (e.g. OCR process). In some variations, data to undergo conversion, or not to undergo conversion, via a character recognition algorithm may be automatically determined by the data processing while in other variations, the user may indicate whether particular writings are to undergo character recognition (e.g. by holding a button during writing, by tapping button before or after writing, or by moving the device through a certain recognizable movement to provide processing start and stop signals). In some applications the device may be used as a three-dimensional drawing tool such as for defining structures or components of a solid model that is being created (e.g. as a data entry device for a 3-D computer aided design system).

In some embodiment variations the writings or drawings captured or interpreted from the handheld device sensors, and/or the captured data itself, may be correlated to other writings/drawings, and/or data associated with these other writings/drawings to establish the similarities and differences between them (e.g. for the purpose of authenticating handwriting or signature of a person. Use of such authentication may allow access to otherwise secured data files, programs, facilities, rooms and the like. Examples of some such applications are provided in a concurrently filed application having Docket No. PASP-006US-A, by Vacit Arat, and entitled “Methods for Using Biometric Authentication Methods for Securing Files and for Providing Secure Access to Such Files by Originators and/or Authorized Others”. This referenced application is incorporated herein by reference as if set forth in full herein.

In view of the teachings herein, many further embodiments, alternatives in design and uses of the embodiments of the instant invention will be apparent to those of skill in the art. As such, it is not intended that the invention be limited to the particular illustrative embodiments, alternatives, and uses described above but instead that it be solely limited by the claims presented hereafter.

I claim:

1. A method for creating a writing or drawing, comprising:
(a) providing a handheld device having at least one inertial measurement sensor;
(b) initiating a writing or drawing capture event;
(c) undergoing a series of writing or drawing motions wherein the motions are detected by the at least one inertial measurement sensor;
(d) ending a writing or drawing capture event; and
(e) processing the motions into a writing or drawing.

2. The method of claim 1 wherein the device comprises a cell phone.

3. The method of claim 2 wherein the cell phone comprises a smart phone.

4. The method of claim 1 wherein the at least one inertial sensor comprises at least one sensor for detecting motion selected from the group consisting of (1) a linear acceleration along an axis; (2) a linear acceleration along at least two perpendicular axes; (3) a linear acceleration along three perpendicular axes; (4) an angular acceleration about an axis; (5) an angular acceleration about at least two perpendicular axes; and (6) an angular acceleration about three perpendicular axes.

5. The method of claim 1 wherein the initiating of a writing capture event occurs by a writer entering a particular application running on the handheld device and by taking an action selected from the group comprising: (1) pressing a button on the body of the device, (2) activating a touch sensor associated with a writing contact feature of the device, (3) applying adequate pressure to a pressure sensor associated with a writing contact feature of the device, (4) causing the device to move through a defined sequence of motions.

6. The method of claim 1 wherein the initiating of writing capture comprises an action selected from the group consisting of (1) moving the device through a defined sequence of motions, (2) one or more contacts with a touch screen on the handheld device, (3) issuance of a voice command.

7. The method of any of claim 1 wherein the writing or drawing motions are also interpreted by an indication from a sensor selected from the group consisting of (1) a proximity sensor that provides a distance indication relative to a surface over which the handheld device is moved, (2) a contact sensor that provides a contact or a no-contact indication relative to a surface over which the handheld device is moved, (3) a pressure sensor that provides a pressure indication when a surface over which the handheld device is moved.

8. The method of claim 1 wherein a camera is used to detect landmarks on a surface over which the device is moved during the writing or drawing motions.

9. The method of claim 1 wherein a camera is used to detect marks on a surface when the device contacts the surface during the writing or drawing motions.

10. The method of claim 9 wherein the marks are the writing or drawings physically made on the surface during the writing or drawing motions.

11. The method of claim 1 wherein the handheld device comprises an element selected from the group consisting of (1) a stylus that is moved against a surface during at least a portion of the writing or drawing motions and wherein the stylus is removed before performing at least one other device function; (2) a writing instrument that can mark a surface and that is moved against a surface during at least a portion of the writing or drawing motions and which is removed before performing at least one other device function; (3) a laser that can at least temporarily mark a surface and that is made to mark the surface during at least a portion of the writing or drawing motions.

12. The method of claim 1 wherein during the writing or drawing motions, a display screen on the device displays an image derived from the writing or drawing being created.

13. The method of claim 1 wherein the writing or drawing motions give rise to data that is transferred from the handheld device to another device and the transferred data is interpreted by the other device to create and display the writing or drawing.

14. The method of claim 1 wherein the writing or drawing motions give rise to data that is transferred from the handheld device to another device, the transferred data is interpreted by the other device, and then sent back to the handheld device to display the writing or drawing.

15. The method of claim 1 wherein the writing or drawing is interpreted as a drawing selected from the group consisting of: (1) a 2-D writing or drawing, (2) a 3-D drawing, and (3) a 3-D solid structure or assembly of solid structures.

16. The method of claim 1 wherein the writing or drawing is interpreted using a character recognition algorithm.

17. The method of claim 1 wherein the processing of the motions into a writing or drawing occurs in real time by the handheld device.

18. The method of claim 1 wherein the processing of the motions into a writing or drawing occurs in after completion of the writing or drawing movements.

19. The method of claim 1 wherein information extracted from the writing or drawing motions are used as part of (1) a text message; (2) a phone number; (3) a web search; (4) a report; (5) notes; and/or (6) a signature.

20. The method of claim 1 wherein information extracted from the writing or drawing motions is compared to previously recorded information to providing a writing analysis, signature verification, or identity verification or confirmation.
